(19) United States
(12) Patent Application Publication
(10) Pub. No.: US 2021/0341763 A1
(43) Pub. Date: Nov. 4, 2021

(54) ANTI-POLLEN GLASSES

(71) Applicant: HWA MAO OPTICAL (XIAMEN) CO., LTD., Xiamen City (CN)

(72) Inventors: TSUNG-WEN CHEN, Xiamen City (CN); Xiaoxian HUANG, Xiamen City (CN)

(21) Appl. No.: 17/034,629

(22) Filed: Sep. 28, 2020

(30) Foreign Application Priority Data
Apr. 30, 2020 (CN) 202020695061.5

(51) Int. Cl. G02C 11/00; G02C 5/00

(52) U.S. Cl. CPC G02C 11/12; G02C 5/001; G02C 5/008

(57) ABSTRACT

The present invention discloses a kind of anti-pollen glasses includes a glass frame and a protection cover, the protection cover is detachably assembled at an outer side of the glass frame and has an accommodation groove adapting to the glass frame, a side wall of the accommodation groove encloses the whole glass frame and forms a protection ring surface, the protection cover is provided with relief windows corresponding to positions of the lenses. The structure of the present invention is simple, a protection cover is added on the basis of regular glasses, and the glasses can be used as the regular glasses after the protection cover is removed. It is convenient for assembling and disassembling, in an environment where anti-pollen is not required, a wearer can easily detach the protection cover to reduce pressure on a face, and can conveniently assemble the protection cover when necessary.

### TECHNICAL FIELD

The present invention relates to the glasses field, and in particular, relates to a kind of anti-pollen glasses.

### BACKGROUND

It is well known that a considerable number of people are allergic to pollen, and the incidence of pollen allergy symptoms is relatively high. When pollen enters the eyes of allergic people, it causes eye itching, unconscious runny nose and other diseases that cause pain to the patients, and thus brings a lot of inconvenience to patients' daily life.

The anti-pollen glasses sold on the domestic market nowadays have complex structures and high costs, or poor appearance. For example, glasses for preventing pollen allergy disclosed by Chinese patent document CN209765191U have components such as a fan, a filter, nozzles, screens and the like, and thus have a complex structure and high manufacturing costs. For another example, prevent pollen glasses disclosed by Chinese patent document CN207851448U are provided with a prevent pollen cover rubber sleeve and a pollen prevent cover, and thus has a poor appearance.

The current anti-pollen glasses can not be separately used by detaching components with anti-pollen function when it is unnecessary to prevent pollen, or have a poor appearance after the components with anti-pollen function are detached, which bring relatively large consumption costs to consumers, and thus, it is difficult to arouse the interest of domestic consumers.

### SUMMARY

The present invention provides a kind of anti-pollen glasses, which has a simple structure, and anti-pollen components that can be detached when it is unnecessary to prevent pollen, and is like regular glasses after the anti-pollen components are detached.

In order to achieve the above purpose, the present invention adopts a following technical solution:

a kind of anti-pollen glasses includes a glass frame and a protection cover, lenses are provided in the glass frame, both ends of the glass frame are connected with glass legs, the protection cover is detachably assembled at an outer side of the glass frame and has an accommodation groove adapting to the glass frame, a side wall of the accommodation groove encloses the whole glass frame and forms a protection ring surface, the protection cover is provided with relief windows corresponding to positions of the lenses, side walls of the relief windows are used as a limiting frame for preventing the glass frame from moving outside, a flange protrudes from inside of the protection ring surface, a mounting groove is formed between the flange and the limiting frame, and an edge of the glass frame can be placed in the mounting groove.

Furthermore, the flange includes a first flange, a second flange and a third flange, the first flange extends from an upper left end of the inner wall of the protection ring surface to an upper right end after passing through a position of a center beam of the glass frame, the second flange extends from a left side of the inner wall of the protection ring surface to a bottom of the inner wall, and the third flange extends from a right side of the inner wall of the protection ring surface to the bottom of the inner wall.

Furthermore, a side of the flange near to a wearer's face is disposed as an inclined surface and smoothly transits to the protection ring surface.

Furthermore, a width of at least partial edge of a side of the protection ring surface near to a wearer's face is extended to form a side guard.

Furthermore, the protection cover has a front end surface integrally connected with the protection ring surface, and the relief windows are disposed on the front end surface.

Furthermore, both ends of the protection cover are provided with detachable connection members, the connection members are provided with groove holes, and the groove holes are used to fix a lanyard.

Furthermore, the both ends of the protection cover are provided with insertion holes, an insertion hole has an elastic abutting part connected to a front side wall of the insertion hole, an inner side of the connection member is provided with a hook part, the hook part is inserted into the insertion hole and hooks a rear side wall of the insertion hole, and the elastic abutting part abuts against a front end of the hook part to prevent the hook part from coming out of the insertion hole.

In comparison with the prior art, the present invention has following advantages:

1. the structure of the present invention is simple, a protection cover is added on the basis of regular glasses, the protection cover and the glass frame are detachably connected in an insertion manner, the glass frame can be directly pulled out from the protection cover, and the glasses can be used as regular glasses after the protection cover is removed.

2. It is convenient for assembling and disassembling, in an environment where anti-pollen is not required, a wearer can easily detach the protection cover to reduce pressure on a face, and can conveniently assemble the protection cover when necessary.

3. The protection cover can be configured with a lanyard to be hang on the wearer's neck, and can be used at any time.

4. There is no need to make a special design on the glass frame, thus, the glasses are non-obtrusive as regular glasses after the protection cover is removed to avoid attracting attention.

### BRIEF DESCRIPTION OF THE DRAWINGS

FIG. 1 is one of schematic perspective views of anti-pollen glasses of Embodiment 1;

FIG. 2 is the other one of the schematic perspective views of the anti-pollen glasses of Embodiment 1;

FIG. 3 is an exploded view of the anti-pollen glasses of Embodiment 1;

FIG. 4 is a schematic perspective view of a protection cover of the anti-pollen glasses of Embodiment 1;

FIG. 5 is a front view of the protection cover of the anti-pollen glasses of Embodiment 1;

FIG. 6 is a cross-section view along a line A-A of FIG. 5;

FIG. 7 is a cross-section view along a line B-B of FIG. 5;

FIG. 8 is a schematic perspective view of anti-pollen glasses of Embodiment 2;

FIG. 9 is a schematic diagram of assembly of a connection member and a protection cover of the anti-pollen glasses of Embodiment 2;

FIG. 10 is a schematic perspective view of the protection cover of the anti-pollen glasses of Embodiment 2; and

FIG. 11 is a schematic perspective view of the connection member of the anti-pollen glasses of Embodiment 2.

### DETAILED DESCRIPTION OF THE EXEMPLARY EMBODIMENTS

The present invention provides accompanying drawings in order to further illustrate respective embodiments. These drawings are a part of the contents disclosed by the present invention, which are mainly used to illustrate the embodiments and can explain an operation principle of the embodiments in cooperation with the relevant depiction in the description. With reference to these contents, those ordinarily skilled in the art should understand other possible embodiments and the advantages of the present invention. The components in the drawings are not drawn in proportion, and similar component symbols are generally used to represent similar components.

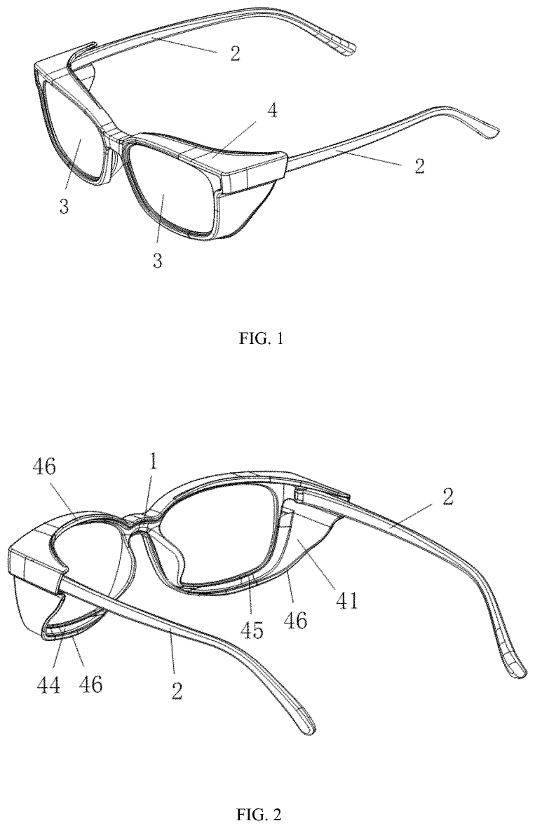

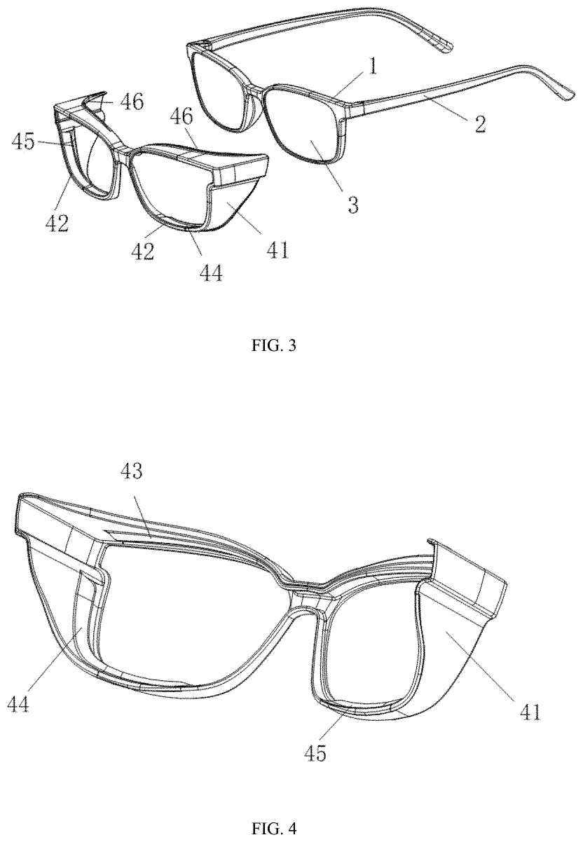

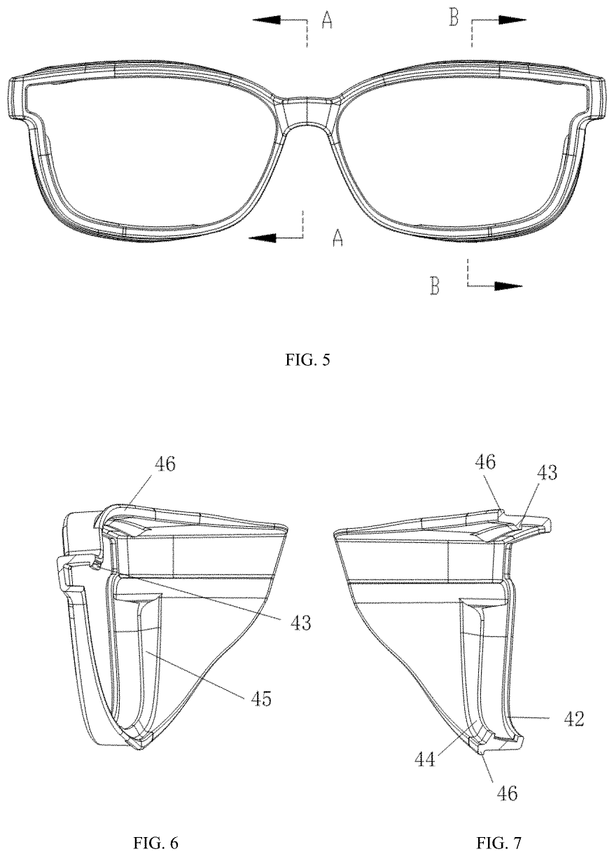

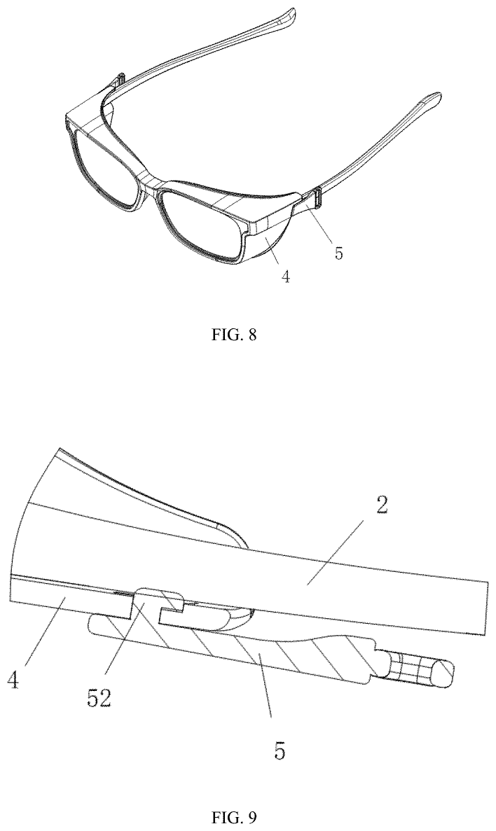

Embodiment 1: As shown in FIG. 1 to FIG. 7, the present embodiment discloses a kind of anti-pollen glasses, including a glass frame 1, glass legs 2 located at both sides of the glass frame 1, two lenses 3 and a protection cover 4. There are many ways to cooperate the glass legs 2 with the glass frame 1, such as hinged connection or engaged connection, which are all the prior art, and will not repeated here. The lenses 3 can be integrally molded with the glass frame 1, and can also be installed in the glass frame 1 in accordance with the prior art. The glass frame 1 is provided with nose pads, and the nose pads can be integrally molded on the glass frame 1, and can also be assembled on the glass frame 1 as separate parts. The protection cover 4 is detachably assembled on an outer side of the glass frame 1, and has an accommodation groove adapting to the glass frame 1, and a side wall of the accommodation groove encloses the whole glass frame 1 and forms a protection ring surface 41.

The protection ring surface 41 is a resist surface extending in a horizontal direction from front to back, or a resist surface that slightly expands externally from front to back, and is mainly used to fill gaps between the glasses and a wearer's face to perform a function of blocking pollen, wind and dust. A width of the protection ring surface 41 is not specifically required, and can be set according to actual situations. An edge of the protection ring surface 41 is used to fit the wearer's face, of which a contour is set to match the wearer's face. The protection ring surface 41 can also be manufactured by using an elastic material to make the fitting more tightly.

The protection cover 4 has a front end surface, the front end surface is integrally connected with the protection ring surface 41 and provided with relief windows corresponding to positions of the lenses 3, side walls of the relief windows are used as a limiting frame 42 to prevent the glass frame 1 from moving outside, a flange protrudes from inside of the protection cover 41, a mounting groove is formed between the flange and the limiting frame 42, and an edge of the glass frame 1 can be placed in the mounting groove. The edge of the glass frame 1 is inserted into the mounting groove in a direct pressing manner, the limiting frame 42 blocks the outside of the glass frame 1, the flange blocks the inside of the glass frame 1. In order to facilitate pressing the edge of the glass frame 1 into the mounting groove, it is preferable to dispose an inner side surface of the flange as an inclined surface having a good guiding function, and it is preferable to dispose the inner side of the flange to smoothly transit to the protection ring surface 41.

The present embodiment takes a frame which is integrally molded with nose pads and is a full frame as an example. The glass frame 1 has a left frame, a right frame and a center beam connecting the left frame and the right frame. As shown in FIG. 2 to FIG. 4, the flange includes a first flange 43, a second flange 44 and a third flange 45, the first flange 43 extends from an upper left end of the inner wall of the protection ring surface 41 to an upper right end after passing through a position of the center beam of the glass frame 1, the second flange 44 extends from a left side of the inner wall of the protection ring surface 41 to a bottom of the inner wall, and the third flange 45 extends from a right side of the inner wall of the protection ring surface 41 to the bottom of the inner wall. The first flange 43 retains an entire top edge of the glass frame 1, that is, retains top edges of the left and right frames and the center beam, the second flange 44 retains left and bottom edges of the left frame and avoids the nose pad on a right side of the left frame, and the third flange 45 retains right and bottom edges of the right frame and avoid the nose pad on a left side of the right frame.

It should be understood that the solution of the present invention can be further applied to rimless glasses and half-rim glasses, and the assemble can be implemented as the widths of the respective mounting grooves adapt to the corresponding glass frame 1 or lenses 3. Lengths of the first frame, the second frame and the third frame can be adjusted, and each can be divided into several discontinuous sections.

The edge of the protection ring surface 41 is used to fit the wearer's face. If a fitting surface is too small, it will cause pressure on the wearer's face and form indentations. In order to avoid this situation, it is preferable to extend a width of at least partial edge of a side of the protection ring surface 41 near to the wearer's face to form a side guard 46.

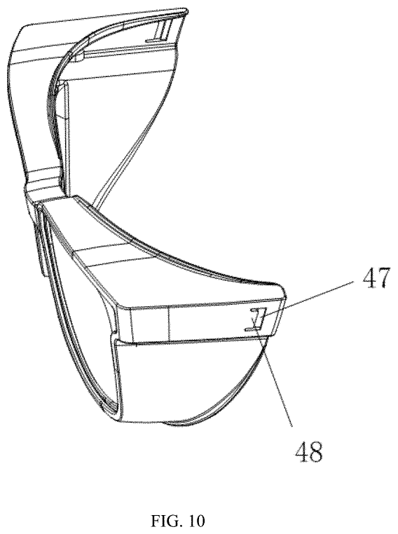

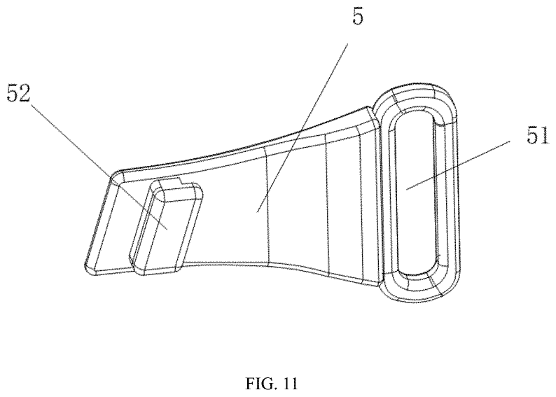

Embodiment 2: Since a user may take off the protection cover at any time, it is considered to configure the protection cover 4 with a lanyard for convenience. The specific solution is: on the basis of Embodiment 1, as shown in FIG. 8 to FIG. 11, both ends of the protection cover 4 can be detachably assembled with connection members 5, respectively, the connection members 5 are provided with groove holes 51, both ends of the lanyard pass through the groove holes 51 on the two connection members 5, respectively and are fastened, or both ends of the lanyard are provided with hang buckles and the hang buckles are hooked on the groove holes 51.

As shown in FIG. 9 to FIG. 11, the two connection members 5 are respectively assembled at left and right outer sides of the protection cover 4, both ends of the protection cover 4 are provided with insertion holes 47, the insertion hole 47 has an elastic abutting part 48 connected to a front side wall of the insertion hole 47, an inner side of the connection member 5 is provided with a hook part 52, the hook part 52 is inserted into the insertion hole 47 and hooks a rear side wall of the insertion hole 47, and the elastic abutting member 48 abuts against a front end of the hook part 52 to prevent the hook part 52 from coming out of the insertion hole 47.

The present embodiment discloses a kind of anti-pollen glasses includes a glass frame and a protection cover 4, lenses are provided in the glass frame, both ends of the glass frame are connected with glass legs 2, the protection cover 4 is detachably assembled at an outer side of the glass frame and has an accommodation groove adapting to the glass frame, a side wall of the accommodation groove encloses the whole glass frame and forms a protection ring surface, the protection cover 4 is provided with relief windows corresponding to positions of the lenses, side walls of the relief windows are used as a limiting frame for preventing the glass frame from moving outside, a flange protrudes from inside of the protection ring surface, a mounting groove is formed between the flange and the limiting frame, and an edge of the glass frame can be paced in the mounting groove. Both ends of the protection cover 4 are provided with detachable connection members 5, the connection members 5 are provided with groove holes 51, and the groove holes 51 are used to fix a lanyard. The both ends of the protection cover 4 are provided with insertion holes 47, an insertion hole 47 has an elastic abutting part 48 connected to a front side wall of the insertion hole, an inner side of the connection member 5 is provided with a hook part 52, the hook part 52 is inserted into the insertion hole 47 and hooks a rear side wall of the insertion hole, and the elastic abutting part 48 abuts against a front end of the hook part 52 to prevent the hook part 52 from coming out of the insertion hole.

Although the present invention is specifically exhibited and introduced in conjunction with the preferable embodiments, those skilled in the art should understand that various changes can be made on forms and details of the present invention without departing from the spirit and scope of the present invention defined by the accompanying claims, and all fall within the protection scope of the present invention.

What is claimed is:

1. A kind of anti-pollen glasses, characterized in comprising: a glass frame and a protection cover, lenses being provided in the glass frame, both ends of the glass frame being connected with glass legs, the protection cover being detachably assembled at an outer side of the glass frame and having an accommodation groove adapting to the glass frame, a side wall of the accommodation groove enclosing the whole glass frame and forming a protection ring surface, the protection cover being provided with relief windows corresponding to positions of the lenses, side walls of the relief windows being used as a limiting frame for preventing the glass frame from moving outside, a flange protruding from inside of the protection ring surface, a mounting groove being formed between the flange and the limiting frame, and an edge of the glass frame capable of being placed in the mounting groove.

2. The anti-pollen glasses of claim 1, which is characterized in that: the flange comprises a first flange, a second flange and a third flange, the first flange extends from an upper left end of the inner wall of the protection ring surface to an upper right end after passing through a position corresponding to a center beam of the glass frame, the second flange extends from a left side of the inner wall of the protection ring surface to a bottom of the inner wall, and the third flange extends from a right side of the inner wall of the protection ring surface to the bottom of the inner wall.

3. The anti-pollen glasses of claim 1, which is characterized in that: a side of the flange near to a wearer's face is disposed as an inclined surface and smoothly transits to the protection ring surface.

4. The anti-pollen glasses of claim 1, which is characterized in that: a width of at least partial edge of a side of the protection ring surface near to the wearer's face is extended to form a side guard.

5. The anti-pollen glasses of claim 1, which is characterized in that: the protection cover has a front end surface integrally connected with the protection ring surface, and the relief windows are disposed on the front end surface.

6. The anti-pollen glasses of claim 1, which is characterized in that: both ends of the protection cover are provided with detachable connection members, the connection members are provided with groove holes, and the groove holes are used to fix a lanyard.

7. The anti-pollen glasses of claim 6, which is characterized in that: The both ends of the protection cover are provided with insertion holes, an insertion hole has an elastic abutting part connected to a front side wall of the insertion hole, an inner side of the connection member is provided with a hook part, the hook part is inserted into the insertion hole and hooks a rear side wall of the insertion hole, and the elastic abutting part abuts against a front end of the hook part to prevent the hook part from coming out of the insertion hole.
